(19) United States
(12) Patent Application Publication
(10) Pub. No.: US 2009/0201932 A1
(43) Pub. Date: Aug. 13, 2009

(54) METHOD AND SYSTEM FOR IMPLEMENTING MPLS NETWORK DIFFSERV TRAFFIC ENGINEERING

(75) Inventors: Amit Kumar, Shenzhen (CN); Zhenbin Li, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/395,420

(22) Filed: Feb. 27, 2009

Related U.S. Application Data
(63) Continuation of application No. PCT/CN2007/070538, filed on Aug. 22, 2007.

(30) Foreign Application Priority Data
Aug. 29, 2006 (CN) 200610112251.4

(51) Int. Cl. H04L 12/56

(52) U.S. Cl. 370/395.5

(57) ABSTRACT

A method for implementing DS-TE in MPLS network is disclosed. The method includes carrying Quality of Service (QoS) parameters relating to resource allocation in a path message when establishing an LSP; reserving bandwidth resource for service traffic according to the QoS parameters; using the reserved bandwidth to forward service traffic after the LSP is established. A system for implementing DE-TE in the MPLS network is also disclosed. The system includes an Ingress LSR, a relay LSR and a Egress LSR. The Ingress LSR or the relay LSR carry QoS parameters relating to the resource allocation in the path message for establishing LSR. The relay LSR reserves bandwidth resource for service traffic based on the QoS parameters and forwards the service traffic based on the reserved bandwidth when receiving the service traffic, after the LSP is established. An LSR is further disclosed according to the present invention. According to the method, system and LSR of the present invention, bandwidth resources can be allocated based on different service class and thus granularity for the DiffServ traffic engineering is further refined.

### CROSS REFERENCE

The application claims the priority of CN application No. 200610112251.4, filed on Aug. 29, 2006 with the State Intellectual Property Office of the People's Republic of China, entitled “METHOD AND SYSTEM FOR IMPLEMEMTING MPLS NETWORK DIFFSERV TRAFFIC ENGINEERING”, the entire contents of which are incorporated herein by reference.

### FIELD OF THE INVENTION

The present invention relates to Multiple Protocol Label Switch (MPLS) and Traffic Engineering (TE) techniques, especially to methods and systems for implementing DiffServ Traffic Engineering (DS-TE) in the MPLS network.

### BACKGROUND

Traffic Engineering (TE) in an MPLS network may realize resource reservation, error tolerance and optimization of transmission resource, while Differentiated Service (DiffServ) may achieve expandable network design by virtue of multi-level services. Combining the merits of DiffServ and TE, the MPLS DiffServ-TE is able to guarantee the Quality of Service (QoS) rigorously and optimize the usage of the network resources.

According to the DiffServ mechanism supported by MPLS as described in RFC 3270, a label switching router (LSR) makes a decision on performing forwarding operation based only on the MPLS header of the data packet, thereby judging the Per Hop Behavior (PHB) of the data packet. A three-bit Experimental Bit (EXP) field is assigned in MPLS message header to bear DiffServ information in the MPLS.

DiffServ supported by MPLS is to establish a TE channel for DiffServ-aware. DiffServ supported by MPLS utilizes two types of label switching path (LSP) to establish the TE channel, namely, LSP (E-LSP, EXP-inferred-LSP) inferred by EXP and LSP (L-LSP, Label-Only-Inferred-LSP) inferred by label only. For solutions using L-LSP, each LSP carries a single Ordered Aggregate (OA). For solutions where E-LSP is used, each LSP may carry multiple OAs.

In the E-LSP solution, a specific EXP combination maps to a specific PHB. The PHB includes scheduling and abandoning priority. During the period of forwarding data packet, the label determines the forwarding path for the data packet, and the EXP determines the PHB. For a single LSP, E-LSP can be employed to bear at most 8 data packets for different per-hop behaviors.

Therefore, because the current E-LSP solution only differentiates the per-hop behaviors for data packets, rather than differentiate the service class, it is impossible to provide the guaranteed bandwidth for different service classes.

### SUMMARY

According to one aspect of the present invention, a method for implementing DS-TE in an MPLS network includes: carrying, by an ingress LSR or a relay LSR, QoS parameters relating to resource allocation in a path message when establishing LSP; reserving bandwidth resource for service traffic according to the QoS parameters relating to the resource allocation; and utilizing the reserved bandwidth to forward the service traffic after LSP is established.

According to one aspect of the present invention, a system for implementing DS-TE in the MPLS network is provided. The system includes an ingress LSR, a relay LSR and an egress LSR. The ingress LSR or the relay LSR carries QoS parameters relating to resource allocation in a Path message when establishing the LSP. Upon receiving the Path message, the relay LSR reserves bandwidth resource for service traffic according to the QoS parameters relating to resource allocation. And the relay LSR forwards the service traffic using the reserved bandwidth after the LSP is established.

According to another aspect of the present invention, an LSR is provided. The LSR includes: a path message generation unit, configured to generate a path message carrying QoS parameters related to resource allocation; a transmitting unit, configured to send the path message generated by the path message generation unit, to an LSR of a next hop.

According to another aspect of the present invention, an LSR is provided. The LSR includes: a path message forwarding unit, configured to receive a path message from an LSR of a previous hop and forward the path message to an LSR of a next hop; and a resource allocation unit, configured to reserve bandwidth resource for service traffic based on QoS parameters carried in the path message received by the path message forwarding unit.

According to another aspect of the present invention, an LSR is provided. The LSR includes: a path message forwarding unit, configured to receive a first path message from an LSR of a previous hop and forward a second path message to an LSR of a next hop; and a path message generation unit, configured to carry QoS parameters relating to resource allocation in the first path message received by the path message forwarding unit, generate a second path message, and send the second path message to the path message forwarding unit.

According to the foregoing technical solutions, fields for identifying the QoS parameters relating to the bandwidth allocation are added to the RSVP path message for establishing E-LSP. In a preferred embodiment, the parameters include a class type parameter and a bandwidth occupation parameter. Different bandwidth resources are reserved on the E-LSP for services of different class types. After the E-LSP is established, the bandwidth is allocated to the service traffic based on the reserved bandwidth resource. As such, allocating bandwidth resources based on different service types can be achieved, thereby further refining the granularity of the DiffServ TE.

### BRIEF DESCRIPTION OF THE DRAWING(S)

FIG. 1 is a structure diagram of a DiffServ object;

FIG. 2 is a diagram of a format of MAP entry field in a conventional DiffServ object;

FIG. 3 is a diagram of a format of MAP field in a DiffServ object according to one preferred embodiment of the present invention;

FIG. 4 is a system diagram of implementing DS-TE in the MPLS network according to one preferred embodiment of the present invention;

FIG. 5 is a flowchart of implementing DS-TE in the MPLS network according to one preferred embodiment of the present invention;

FIG. 6 is a structure diagram of LSR according to the present invention;

FIG. 7 is another structure diagram of LSR according to the present invention; and

FIG. 8 is yet another structure diagram of LSR according to the present invention.

### DETAILED DESCRIPTION

The purpose, technical solutions and advantages concerning the embodiments of the present invention will become more readily appreciated by reference to the following description of the embodiments, when taken in conjunction with the accompanying drawings. It should be understood that the embodiments described herein are merely illustrations of the present invention and are not limiting in these respects.

To achieve differentiated service in MPLS, an object related to DiffServ—DiffServ Object—needs to be added in a Path message when establishing the LSP. The DiffServ parameters are carried in the DiffServ object.

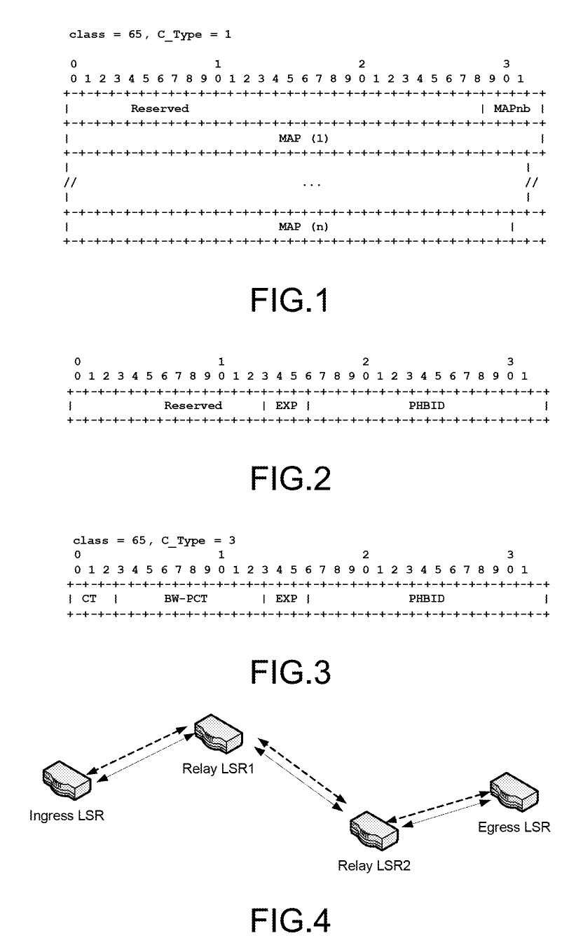

FIG. 1 is a diagram of a DiffServ object in the Path message. As shown in FIG. 1, DiffServ object includes:

Reserved field: 28-bit. This field is reserved. The field is set to 0 in time of transmission and is ignored in time of reception.

MAPnb field: 4-bit, indicating the number of MAP entries included in the DiffServ object, the value of which is in the range of 0 to 7.

MAP field: 32-bit. Each MAP entry defines the mapping between an EXP field value and a PHB field value.

FIG. 2 is a diagram of a format of MAP entry field in the existing DiffServ object. Referring to FIG. 2, each MAP entry includes the following fields:

Reserved field: 13-bit. This field is reserved. The field is set to 0 in time of transmission and is ignored in time of reception.

EXP field: 3-bit. The value of this field serves as the EXP value in the EXP-PHB mapping relating to the MAP entry.

PHBID: 16-bit. The value of this field serves as the ID of PHB in the EXP-PHB mapping relating to the MAP entry.

According to the embodiment of the present invention, fields for identifying the QoS parameters relating to the bandwidth allocation are added to the RSVP path message for establishing E-LSP. Different bandwidth resources are reserved on the E-LSP for different services. After the E-LSP is established, the bandwidth is allocated to the service traffic based on the reserved bandwidth resource.

According to the preferred embodiment of the present invention, MAP entry of DiffServ object regarding the Path message is extended. Specifically, a CT field for identifying class type and a field for indicating the bandwidth occupation are added in the MAP entry.

According to RFC 3564, CT is a set of traffic relay sections for crossing links. The CT is managed by a specific set of bandwidth restriction conditions. CT is used in bandwidth allocation, routing based on restriction conditions and admission control. Specified traffic relay sections on all links belong to a same CT.

FIG. 3 is a diagram of MAP field formats for DiffServ object according to one preferred embodiment of the present invention. Referring to FIG. 3, according to the embodiment, each MAP entry includes the following fields:

CT field: 3-bit. Such field includes a class type value for identifying, in the MPLS message, the class type of the data packet containing the EXP value.

BW-PCT field: 10-bit. This field identifies the percentage of the bandwidth occupied by the data packet of a CT to the bandwidth of the whole channel. At MAP entry, BW-PCT takes up 10 bits so that the percentage of bandwidth occupied by the BW type to the whole bandwidth reaches the precision of 0.1%.

Moreover, the extended MAP entry further includes an EXP field and a PHBID field. The definition for these two fields can be the same as those of EXP field and PHBID field illustrated in FIG. 2, which is omitted herein for brevity.

As can be seen from the structure of MAP entry as illustrated in FIG. 3, the CT field which identifies the class type and the BW-PCT field which identifies the bandwidth occupation are added in the extended MAP entry. As such, allocating different bandwidth sources, e.g., allocating different bandwidths, for data traffics of different class types can be achieved by dividing the service traffics relating to the same E-LSP into different class types.

FIG. 4 is a system diagram of implementing DS-TE in the MPLS network according to one preferred embodiment of the present invention; As shown in FIG. 4, in this embodiment, the system includes an ingress LSR, a relay LSR and an egress LSR.

When establishing the E-LSP, the ingress LSR sends a RSVP Path message (Path message for short) to the egress LSR via the relay LSR on a path designated by the management layer. The Path message includes QoS parameters such as CT and BW-PCT. In the forwarding process, each relay LSR reserves bandwidth resources for service traffic based on the parameters CT and BW-PCT carried in the Path message. After the egress LSR receives the Path message, the egress LSR returns a RSVP response (Resv) message in a reverse direction of the forwarding path carried in the Path message. After the ingress LSR receives the Resv message, the E-LSP path is established.

After the E-LSP path is established, and after the ingress LSR receives the data packet, the MPLS header is added to the data packet. After the data packet is encapsulated as an MPLS message, the MPLS message is forwarded via the established E-LSP till the path message is forwarded to the egress LSR. During the forwarding process, each relay LSR allocates bandwidth for service traffic based on the reserved bandwidth resources.

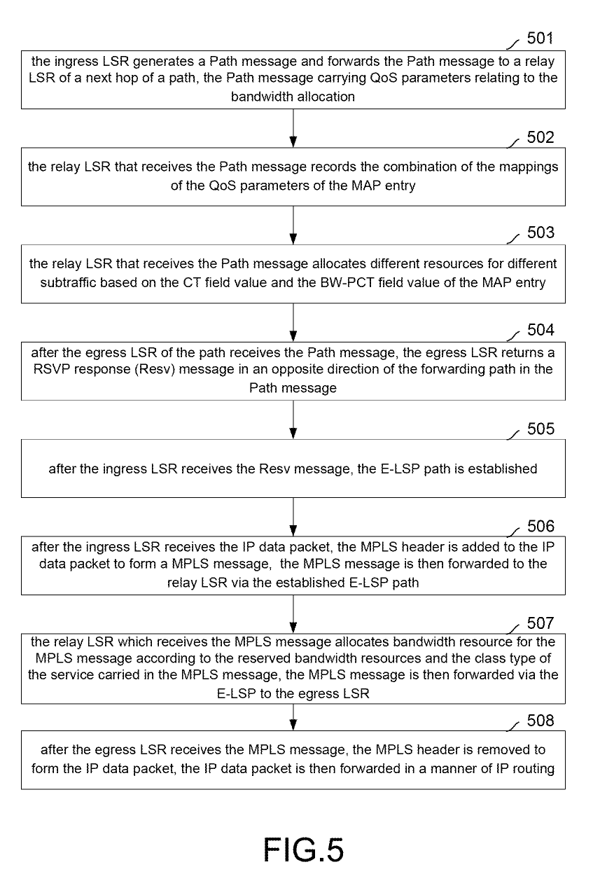

FIG. 5 is a flowchart of implementing DS-TE in the MPLS network according to one preferred embodiment of the present invention; As shown in FIG. 5, in this preferred embodiment, the method for implementing DS-TE in MPLS network primarily includes the following steps:

Step 501: The ingress LSR generates a Path message and forwards the Path message to a relay LSR of a next hop of a path. The Path message carries QoS parameters relating to the bandwidth allocation.

According to the present embodiment, the QoS parameters relating to the bandwidth allocation are carried in the extended MAP entry of the DiffServ object in the Path message. The DiffServ object includes the extended MAP entry as illustrated in FIG. 3.

The MAP entry includes a CT field and a BW-PCT field. Each MAP entry corresponds to a type of service so that service traffic of different class type may correspond to a different percentage of the bandwidth occupation. Because the MPLS message may carry various types of service traffic corresponding to various class types, each type of service traffic is referred to as a service subtraffic.

Because the BW-PCT field identifies the percentage of the bandwidth occupation, the ingress LSR needs to include the information of the whole bandwidth information in the Path message, i.e. the summation of the bandwidths that service subtraffics of all types take up. Preferably, a Sender Tspec object in the Path message carries the information of the whole bandwidth.

Step 502: The relay LSR that receives the Path message records the combination of the mapping of the QoS parameters of the MAP entry.

The mapping among each QoS parameter is described as CT←→BW-PCT←→EXP←→PHB, which means that composition of each mapping includes a CT value, a BW-PCT value, an EXP value and a PHB value. In this embodiment, combinations of at most 8 mappings are available. That is, different configurations for bandwidth resources are available for at most 8 types of service subtraffics.

Step 503: The relay LSR that receives the Path message allocates different resources for different subtraffic based on the CT field value and the BW-PCT field value of the MAP entry. Further, different scheduling and forwarding priorities are assigned to different subtraffics based on the EXP field value and the PHBID field value.

According to the embodiment, the BW-PCT is the percentage of bandwidth occupied by the class type. Therefore, the relay LSR needs to calculate the value of bandwidth corresponding to each class type based on the information of the whole bandwidth carried in the Sender Tspec object in the Path message.

Step 504: After the egress LSR of the path receives the Path message, the egress LSR returns an RSVP response (Resv) message in an opposite direction of the forwarding path in the Path message.

Step 505: After the ingress LSR receives the Resv message, the E-LSP path is established.

Step 506: After the ingress LSR receives the IP data packet, the MPLS header is added to the IP data packet to form an MPLS message. The MPLS message is then forwarded to the relay LSR via the established E-LSP path.

Step 507: The relay LSR which receives the MPLS message allocates bandwidth resource for the MPLS message according to the reserved bandwidth resources and the class type carried in the MPLS message. The MPLS message is then forwarded via the E-LSP to the egress LSR.

Step 508: After the egress LSR receives the MPLS message, the MPLS header is removed to form the IP data packet. The IP data packet is then forwarded in a manner of IP routing.

As can be seen from the above, when establishing E-LSP, the ingress LSR adds parameters for identifying class type and for indicating bandwidth occupation in the Path message. Each relay LSR reserves bandwidth resource for service traffic according to the parameters indicating class type and bandwidth occupation carried in the Path message. After the E-LSP is established, each relay LSR allocates bandwidth for service traffic according to the reserved bandwidth resources.

Therefore, in the MPLS network, allocating resources based on the class type and the bandwidth occupation of each service subtraffic can be achieved so that different service can be allocated with different resources.

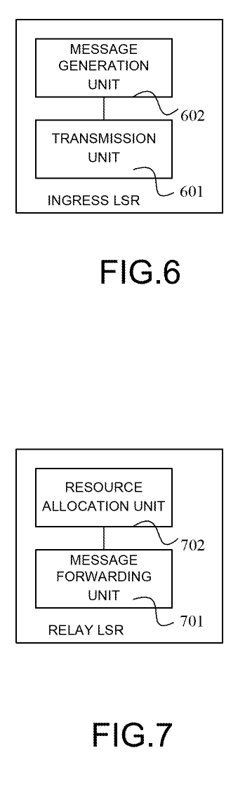

FIG. 6 is a structure diagram of the ingress LSR according to one preferred embodiment of the present invention. As illustrated in FIG. 6, the LSR includes a transmission unit 601 and a path message generation unit 602. The transmission unit 601 sends the Path message. The path message generation unit 602 carries QoS parameters relating to the resource allocation in the Path message, and sends the Path message out by the transmission unit 601. Specifically, the path message generation unit 602 carries QoS parameters relating to the bandwidth allocation in the extended MAP entry of the DiffServ object in the Path message. The QoS parameters include class type and bandwidth occupation.

FIG. 7 is a structure diagram of the ingress LSR according to one preferred embodiment of the present invention. As illustrated in FIG. 7, the LSR includes a path message forwarding unit 701 and a resource allocation unit 702. The path message forwarding unit 701 receives the Path message from the LSR of previous hop, and sends the Path message to the LSR of a next hop. The resource allocation unit 702 reserves bandwidth resources for the service traffic according to the QoS parameters in the Path message.

It should be understood that although the specification only take class type and bandwidth occupation as illustration for adding QoS parameters relating to the bandwidth allocation in the Path message, the present invention further includes adding other QoS parameters in the Path message so as to implement a more optimized DS-TE solution in the MPLS network. In addition, the present invention further includes carrying the QoS parameters relating to the bandwidth allocation in the Path message by the relay LSR.

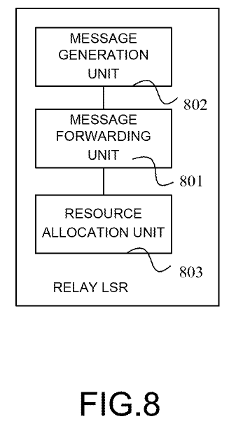

FIG. 8 is a structure diagram of the relay LSR for carrying QoS parameters in the Path message. As illustrated in FIG. 8, the LSR includes a path message forwarding unit 801, a path message generation unit 802 and a resource allocation unit 803. The path message forwarding unit 801 receives the Path message from the LSR of previous hop, and sends a new Path message generated by the path message generation unit 802 to the LSR of a next hop. The path message generation unit 802 carries the QoS parameters relating to the resource allocation in the Path message received by the path message forwarding unit 801, generates a new Path message, and sends the new Path message to the path message forwarding unit 801. The resource allocation unit 803 reserves bandwidth resources for the service traffic according to the QoS parameters in the Path message.

The foregoing are merely exemplary embodiments of the present invention, which shall not be construed as a limitation to the present invention. Any modifications, equivalents, improvements made within the spirit and principle of the present invention fall within the scope of the present invention.

What is claimed is:

1. A method for implementing differentiated service traffic engineering in a multiple protocol label switch (MPLS) network, comprising:
generating a Path message, the Path message bearing Quality of Service (QoS) parameters relating to resource allocation;
forwarding the Path message to a next hop.

2. The method of claim 1, further comprising:
receiving a Resv message from the next hop;
establishing a label switching path (LSP); and
reserving bandwidth resource for a service traffic based on the QoS parameters relating to resource allocation.

3. The method of claim 2, wherein the LSP is an EXP-inferred-LSP (E-LSP).

4. The method of claim 1, wherein the QoS parameters relating to resource allocation comprise class type and bandwidth occupation.

5. The method of claim 1, wherein the QoS parameters relating to resource allocation comprise:
a field indicating class type and a field indicating bandwidth occupation percentage in a MAP entry to which each service traffic corresponds; and
information of whole bandwidth occupied by all class types in the path message.

6. The method of claim 5, wherein the bandwidth resources reserved for a service traffic is a product of the percentage of bandwidth occupation in the MAP entry to which the service traffic corresponds and the whole bandwidth occupied by all class types carried in the path message.

7. A method for implementing differentiated service traffic engineering in a multiple protocol label switch (MPLS) network, comprising:
receiving a first Path message from a previous hop, the Path message bearing QoS parameters relating to resource allocation;
generating, based on the QoS parameters relating to resource allocation, a second Path message;
forwarding the second Path message to a next hop.

8. The method of claim 7, further comprising:
receiving a Resv message from the next hop;
reserving bandwidth resource for a service traffic based on the QoS parameters relating to resource allocation.

9. The method of claim 7, wherein the QoS parameters relating to resource allocation comprise class type and bandwidth occupation.

10. The method of claim 7, wherein the QoS parameters relating to resource allocation comprise:
a field indicating class type and a field indicating bandwidth occupation percentage in a MAP entry to which each service traffic corresponds; and
information of whole bandwidth occupied by all class types in the Path message.

11. The method of claim 10, wherein the bandwidth resources reserved for a service traffic is a product of the percentage of bandwidth occupation in the MAP entry to which the service traffic corresponds and the whole bandwidth occupied by all class types carried in the path message.

12. A system for implementing differentiated service traffic engineering in an MPLS network, comprising an ingress label switching router (LSR), a relay LSR, and an egress LSR, wherein
the ingress LSR is configured to bear Quality of Service (QoS) parameters relating to resource allocation in a first Path message, and forward the first Path message to the relay LSR,
the relay LSR, as a next hop of the ingress LSR, is configured to receive the first Path message from the ingress LSR, generate a second Path message based on the QoS parameters relating to resource allocation, and forward the second Path message to the egress LSR,
the egress LSR, as a next hop of the relay LSR, is configured to receive the second Path message from the relay LSR.

13. The system of claim 12, wherein
the egress LSR is further configured to send a Resv message, in a reverse directionto the relay LSR;
the relay LSR is further configured to reserve bandwidth resource for a service traffic based on the QoS parameters relating to resource allocation after receiving the Resv message from the egress LSR and forward the Resv message, in a reverse direction to the ingress LSR;
the ingress LSR is further configured to establish a label switching path (LSP) after receiving the Resv message from the relay LSR and reserve bandwidth resource for a service traffic based on the QoS parameters relating to resource allocation.

14. The system of claim 13, wherein, the LSP is an E-LSP.

15. A label switching router (LSR), comprising:
a module configured to generate a first Path message, the first Path message bearing Quality of Service (QoS) parameters relating to resource allocation; and
a module configured to forwarding the first Path message to a next hop.

16. The LSR of claim 15, further comprising:
a module configured to receive a first Path message from a previous hop;
a module configured to generating a second Path message based on the QoS parameters relating to resource allocation; and
a module configured to forward the second Path message to a next hop.

17. The LSR of claim 16, further comprising:
a module configured to receive a Resv message from the next hop;
a module configured to reserve bandwidth resource for a service traffic based on the QoS parameters relating to resource allocation; and
a module configured to send the Resv message, in a reverse direction to the previous hop.

18. The LSR of claim 17, while the LSR is an ingress LSR, further comprising; a module configured to establish a label switching path (LSP)upon a Resv message;

19. The LSR of claim 18, wherein the LSP is an EXP-inferred-LSP (E-LSP).

20. The LSR of claim 15, wherein the QoS parameters relating to resource allocation comprise class type and bandwidth occupation.

21. The LSR of claim 15, wherein the QoS parameters relating to resource allocation comprise:
a field indicating class type and a field indicating bandwidth occupation percentage in a MAP entry to which each service traffic corresponds; and
information of whole bandwidth occupied by all class types in the path message.

22. The LSR of claim 21, wherein the bandwidth resources reserved for a service traffic is a product of the percentage of bandwidth occupation in the MAP entry to which the service traffic corresponds and the whole bandwidth occupied by all class types carried in the path message.
